(19) United States
(12) Patent Application Publication
(10) Pub. No.: US 2022/0252430 A1
(43) Pub. Date: Aug. 11, 2022

(54) RESOLVER

(71) Applicant: FUTABA CORPORATION, Mobara-shi (JP)

(72) Inventors: Takashi URAHAMA, Mobara-shi (JP); Kazuhiro TAKAHASHI, Mobara-shi (JP)

(73) Assignee: FUTABA CORPORATION, Mobara-shi (JP)

(21) Appl. No.: 17/666,075

(22) Filed: Feb. 7, 2022

(30) Foreign Application Priority Data
Feb. 8, 2021 (JP) 2021-018247

(51) Int. Cl. G01D 5/20

(52) U.S. Cl. CPC G01D 5/2066

(57) ABSTRACT

There is provided a resolver comprising: a main body including an excitation coil to which an excitation signal is input and a detection coil configured to output a detection signal, wherein one of the excitation coil and the detection coil is provided in a fixed part and the other one thereof is provided in a rotating part; and a signal processor configured to detect a rotation angle of the rotating part on the basis of the detection signal that changes in accordance with the rotation angle.

### TECHNICAL FIELD

The present disclosure relates to a technical field of a structure of a resolver.

### BACKGROUND

A resolver, which includes two-phase excitation coils provided in a fixed part with output phases different by 90° and to which an excitation signal is input and a detection coil provided in a rotating part and configured to output a detection signal, and is configured to detect a rotation angle of the rotating part from a phase difference between the excitation signal and the detection signal, is known.

For example, Japanese Laid-open Patent Publication No. 2000-292205 discloses a resolver which includes an excitation coil to which an excitation signal is input and a detection coil configured to output a detection signal, and is configured to detect a rotation angle of a passive element, in which the excitation coil or the detection coil is provided, on the basis of the detection signal that changes in accordance with the amount of displacement of the passive element, wherein the detection signal is obtained by inputting a modulated signal, which is obtained by modulating a high-frequency signal using the excitation signal, to the excitation coil and demodulating the modulated signal output from the detection coil.

### SUMMARY

In the resolver as disclosed in Japanese Laid-open Patent Publication No. 2000-292205, it is desired to maintain or improve detection accuracy of the rotation angle. But here, a distance relationship between each of the excitation coils of two phases, to which the excitation signal is input, and the detection coil configured to output the detection signal may affect an output of the detection signal and thus may be one factor for reducing the detection accuracy of the rotation angle.

Thus, the present invention proposes a structure of a resolver capable of suppressing a decrease in detection accuracy of a rotation angle caused by a difference in distance between a detection coil and each of two-phase excitation coils.

One aspect of the present invention provides a resolver including a main body including an excitation coil to which an excitation signal is input and a detection coil configured to output a detection signal, wherein one of the excitation coil and the detection coil is provided in a fixed part and the other one thereof is provided in a rotating part and a signal processor configured to detect a rotation angle of the rotating part on the basis of the detection signal that changes in accordance with the rotation angle, wherein the fixed part or the rotating part, in which the excitation coil is provided, includes a first coil layer and a second coil layer each formed in a planar shape, and a first insulating layer formed between the first coil layer and the second coil layer, the excitation coil includes a sine coil and a cosine coil, the sine coil is formed by connecting a first sine coil part formed in the first coil layer and a second sine coil part formed in the second coil layer through a first through hole formed in the first insulating layer, the cosine coil is formed by connecting a first cosine coil part formed in the first coil layer and a second cosine coil part formed in the second coil layer through a second through hole formed in the first insulating layer, in the first coil layer, the first sine coil part and the first cosine coil part are alternately arranged in a circumferential direction, and in the second coil layer, the second sine coil part and the second cosine coil part are alternately arranged in the circumferential direction.

As a result, a distance from the detection coil to the first sine coil and a distance from the detection coil to the first cosine coil are equal to each other, and a distance from the detection coil to the second sine coil and a distance from the detection coil to the second cosine coil are equal to each other.

The first sine coil part and the first cosine coil part may be alternately arranged by every one cycle of a conductor pattern, and the second sine coil part and the second cosine coil part may be alternately arranged by every one cycle of a conductor pattern.

As a result, a difference in the amount of magnetic flux, which is generated from the sine coil and the cosine coil in the excitation coil, linked to the detection coil is reduced.

The first sine coil part and the second cosine coil part may be provided at positions opposite to each other with the first insulating layer therebetween, and the second sine coil part and the first cosine coil part may be provided at positions opposite to each other with the first insulating layer therebetween.

As a result, a space for forming the sine coil or the cosine coil is secured.

The one cycle of the first sine coil part may be formed by connecting a first outer peripheral line and a first inner peripheral line via a first radial direction line, the one cycle of the first cosine coil part may be formed by connecting a second outer peripheral line and a second inner peripheral line via a second radial direction line, the first through hole may be formed on a circumference along the first outer peripheral line or on a circumference along the first inner peripheral line, and the second through hole may be formed on a circumference along the second outer peripheral line or on a circumference along the second inner peripheral line.

As a result, an output from each of the first sine coil part and the first cosine coil part is not interfered with by the through hole formed in the first insulating layer.

The fixed part or the rotating part, in which the excitation coil is provided, may further include a third coil layer and a fourth coil layer each formed in a planar shape, a second insulating layer formed between the third coil layer and the fourth coil layer, and a third insulating layer formed between the second coil layer and the third coil layer, wherein the sine coil may be formed by connecting a third sine coil part formed in the third coil layer and a fourth sine coil part formed in the fourth coil layer through a through hole formed in the second insulating layer, and connecting the second sine coil part and the third sine coil part through a through hole formed in the third insulating layer, and the cosine coil may be formed by connecting a third cosine coil part formed in the third coil layer and a fourth cosine coil part formed in the fourth coil layer through a through hole formed in the second insulating layer, and connecting the second cosine coil part and the third cosine coil part through a through hole formed in the third insulating layer, in the third coil layer, the third sine coil part and the third cosine coil part may be alternately provided in the circumferential direction by every one cycle of a conductor pattern, in the fourth coil layer, the fourth sine coil part and the fourth cosine coil part may be alternately provided in the circumferential direction by every one cycle of a conductor pattern, the first sine coil part and the third sine coil part may be provided at positions opposite to each other with the third insulating layer therebetween such that conductor patterns thereof are shifted from each other by half a cycle, and the first cosine coil part and the third cosine coil part may be provided at positions opposite to each other with the third insulating layer therebetween such that conductor patterns thereof are shifted from each other by half a cycle.

As a result, in addition to the magnetic flux generated in the original direction, magnetic flux in a reverse direction is generated in a region of each of the outer peripheral side and the inner peripheral side of the conductor pattern so that the magnetic fluxes thereof cancel.

### BRIEF DESCRIPTION OF THE DRAWINGS

FIG. 1 is a side cross-sectional view illustrating an internal structure of a main body in an embodiment of the present invention.

FIG. 2 is a side cross-sectional view schematically illustrating a positional relationship between a detection-side sheet coil part and an excitation-side sheet coil part in the present embodiment.

FIG. 3 is a block diagram illustrating a functional configuration of a signal processor in the present embodiment.

FIG. 4 is a diagram schematically illustrating a detection-side first coil layer in the present embodiment.

FIG. 5 is a diagram schematically illustrating a detection-side second coil layer in the present embodiment.

FIG. 6 is an enlarged view of a partial region of the detection-side first coil layer in the present embodiment.

FIG. 7 is a side cross-sectional view schematically illustrating a positional relationship between a detection-side sheet coil part and an excitation-side sheet coil part in Comparative Example.

FIG. 8 is a diagram schematically illustrating an excitation-side first coil layer in the present embodiment.

FIG. 9 is a diagram schematically illustrating the excitation-side first coil layer in the present embodiment.

FIG. 10 is a diagram schematically illustrating an excitation-side second coil layer in the present embodiment.

FIG. 11 is an enlarged view of a partial region of the excitation-side first coil layer in the present embodiment.

FIG. 12 is a side cross-sectional view schematically illustrating a positional relationship between a detection-side sheet coil part and an excitation-side sheet coil part in the present embodiment.

FIG. 13 is a diagram illustrating a partial region of the excitation-side sheet coil part in the present embodiment.

FIGS. 14A and 14B are diagrams illustrating partial regions of an excitation-side first coil layer and an excitation-side third coil layer in the present embodiment, respectively.

### DETAILED DESCRIPTION

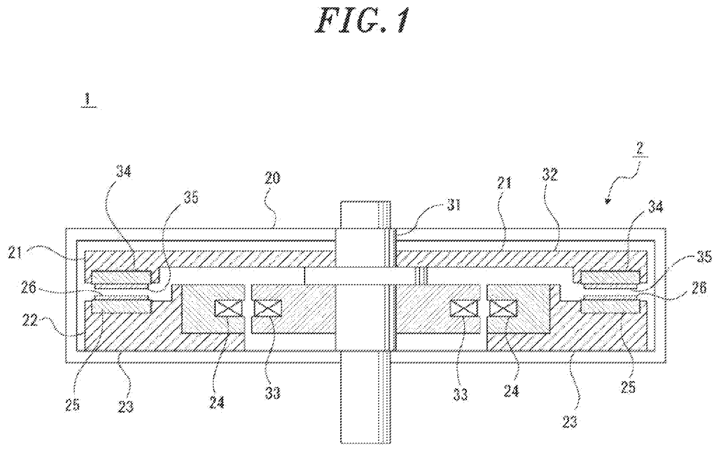

Hereinafter, embodiments will be described with reference to FIGS. 1 to 11.

In addition, it should be noted that components described in the drawings referred to in the description of the present embodiment are shown by extracting main parts and their peripheral components required for realizing the present embodiment. In addition, the drawings are schematic, and a relationship, a ratio, and the like between a thickness and a planar dimension of each structure described in the drawings are merely examples. Accordingly, various modifications may be made in accordance with a design or the like as long as it does not depart from the technical spirit of the present invention.

<1. Configuration Example of Resolver>

A configuration example of a resolver 1 in the present embodiment will be described with reference to FIGS. 1 to 3.

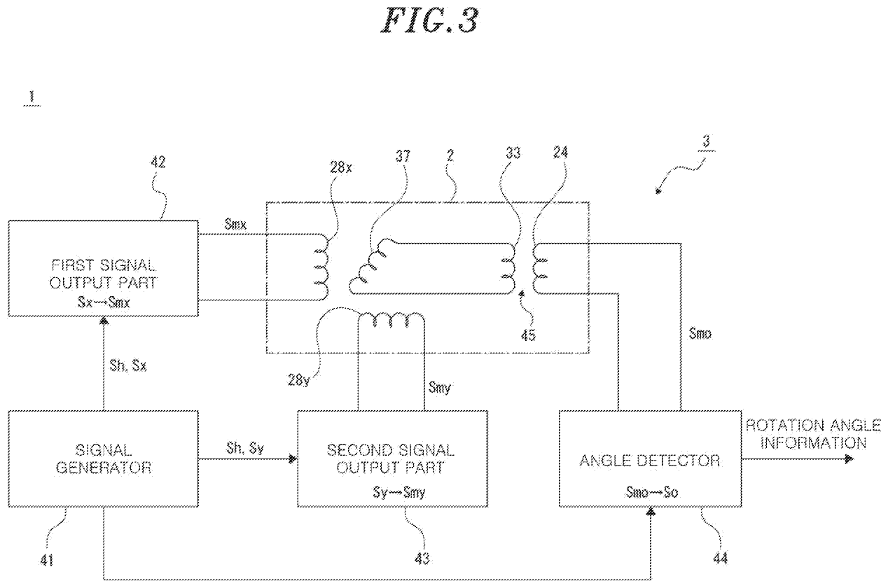

The resolver 1 includes a main body 2 illustrated in FIG. 1 and a signal processor 3 illustrated in FIG. 3.

A configuration example of the main body 2 will be described. FIG. 1 is a side cross-sectional view illustrating an internal structure of the main body 2. The main body 2 includes a rotating part 21 rotatably supported on a center of a casing 20, and a fixed part 22 fixed to the casing 20.

The rotating part 21 includes a rotation shaft 31, a rotating plate 32, a primary coil 33, an iron core 34, and a detection-side sheet coil part 35.

The rotating plate 32 is fixed to the rotation shaft 31. In addition, the primary coil 33 is provided on the rotation shaft 31. The primary coil 33 constitutes an output transformer 45, which is illustrated in FIG. 3, together with a secondary coil 24 to be described below.

The iron core 34 formed in a ring shape is fixed on one surface of the rotating plate 32.

The detection-side sheet coil part 35 formed of a flexible printed circuit board or the like is mounted on a surface of the iron core 34.

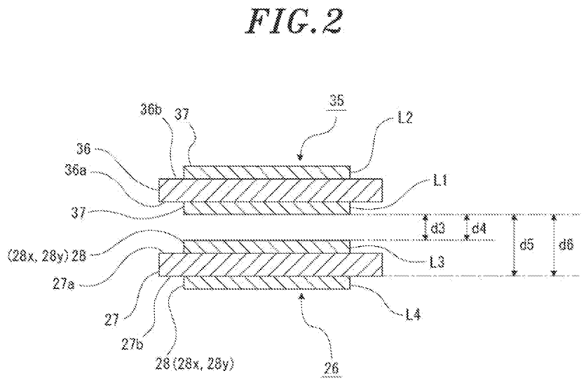

A configuration example of the detection-side sheet coil part 35 will be described with reference to FIG. 2. FIG. 2 is a side cross-sectional view schematically illustrating a positional relationship between the detection-side sheet coil part 35 and an excitation-side sheet coil part 26 to be described below.

The detection-side sheet coil part 35 includes an insulating layer 36 and a detection coil 37.

The insulating layer 36 is formed in a ring shape, and the detection coil 37 is formed in a planar shape on a surface 36a and a rear surface 36b of the insulating layer 36.

In the following description, for convenience of description, a planar region, in which the detection coil 37 is formed, on a side of the surface 36a is referred to as a detection-side first coil layer L1, and a planar region, in which the detection coil 37 is formed, on a side of the rear surface 36b is referred to as a detection-side second coil layer L2.

Returning to the description of FIG. 1. The fixed part 22 includes a base 23, the secondary coil 24, an iron core 25, and the excitation-side sheet coil part 26.

The base 23 is formed in a ring shape and is fixed to the casing 20.

The secondary coil 24 is provided close to a center of the base 23, and the iron core 25 formed in a ring shape is fixed to one surface of the base 23, which is located closer to an outer circumference of the base 23. The secondary coil 24 constitutes the output transformer 45 as illustrated in FIG. 3 together with the primary coil 33.

The excitation-side sheet coil part 26 formed of a flexible printed circuit board or the like is installed on a surface of the iron core 25 so as to face the detection-side sheet coil part 35.

As illustrated in FIG. 2, the excitation-side sheet coil part 26 includes an insulating layer 27 and an excitation coil 28.

The insulating layer 27 is formed in a ring shape, and the excitation coil 28 is formed in a planar shape on a surface 27a and a rear surface 27b of the insulating layer 27.

In the following description, for convenience of description, a planar region, in which the excitation coil 28 is formed, on a side of the surface 27a is referred to as an excitation-side first coil layer L3, and a planar region, which the excitation coil 28 is formed, on a side of the rear surface 27b is referred to as an excitation-side second coil layer L4.

In the excitation-side sheet coil part 26, two excitation coils 28, such as excitation coils 28x and 28y illustrated in FIG. 3, are formed.

Each of the excitation coils 28x and 28y is formed in the excitation-side first coil layer L3 illustrated in FIG. 2, and each of the excitation coils 28x and 28y is also formed in the excitation-side second coil layer L4.

The excitation coils 28x and 28y are insulated from each other due to the insulating layer 27 and are connected between the excitation-side first coil layer L3 and the excitation-side second coil layer L4 through a through hole (not shown) formed in the insulating layer 27.

The excitation coils 28x and 28y are formed such that phases of signals generated on a side of the detection coil 37 by respective signal outputs differ by 90°, and due to this, the excitation coil 28x functions as an excitation coil on a sine-phase side, and the excitation coil 28y functions as an excitation coil on a cosine-phase side.

In the following description, the excitation coil 28x on the sine-phase side is referred to as a sine coil 28x, and the excitation coil 28y on the cosine-phase side is referred to as a cosine coil 28y.

Next, a configuration example of the signal processor 3 will be described with reference to FIG. 3. FIG. 3 is a block diagram illustrating a functional configuration of the signal processor 3.

The signal processor 3 includes a signal generator 41, a first signal output part 42, a second signal output part 43, and an angle detector 44.

The signal generator 41 generates a counter pulse on the basis of a clock signal that is generated using a crystal oscillator (not shown), and generates a high-frequency signal Sh having a frequency of about 1 MHz on the basis of the generated counter pulse.

Further, the signal generator 41 generates excitation signals Sx and Sy each having a frequency of about 1 kHz on the basis of the generated high-frequency signal Sh.

The high-frequency signal Sh and the excitation signal Sx are input to the first signal output part 42 from the signal generator 41.

The first signal output part 42 inverts a polarity of the high-frequency signal Sh at a polarity inversion position of the excitation signal Sx, and modulates the high-frequency signal Sh, whose polarity is inverted, using the excitation signal Sx to generate a modulated signal Smx.

The first signal output part 42 supplies the generated modulated signal Smx to the sine coil 28x.

The high-frequency signal Sh and the excitation signal Sy are input to the second signal output part 43 from the signal generator 41.

The second signal output part 43 inverts a polarity of the high-frequency signal Sh at a polarity inversion position of the excitation signal Sy, and modulates the high-frequency signal Sh, whose polarity is inverted, using the excitation signal Sy to generate a modulated signal Smy.

The second signal output part 43 supplies the generated modulated signal Smy to the cosine coil 28y.

As described above, the modulated signal Smx is supplied to the sine coil 28x, and the modulated signal Smy is supplied to the cosine coil 28y, so that magnetic flux of two phases exhibiting a periodic change with a phase difference of 90° is simultaneously generated in the excitation-side sheet coil part 26, and the magnetic flux of two phases is detected as a modulated signal Smo by the detection coil 37 of the detection-side sheet coil part 35.

The modulated signal Smo detected by the detection coil is supplied to the angle detector 44 via the output transformer 45.

The angle detector 44 demodulates the modulated signal Smo output from the secondary coil 24 of the output transformer 45, and acquires a detection signal So by performing various correction processes as needed.

Further, the angle detector 44 acquires a signal, which is required for detecting an angle, such as the counter pulse acquired from the signal generator 41.

A phase of the detection signal So changes in accordance with the rotation of the rotating part 21 in FIG. 1. The angle detector 44 detects a phase difference in the detection signal So on the basis of the signal acquired from the signal generator 41, and calculates a rotation angle of the rotating part 21 on the basis of the detected phase difference.

The angle detector 44 outputs information about the calculated rotation angle to an external device or the like.

As described above, in the resolver 1 in the embodiment, since the modulated signals Smx, Smy, and Smo, which are modulated using the high-frequency signal Sh, flow respectively through the sine coil 28x, the cosine coil 28y, and the detection coil 37, a sufficient voltage may be induced in the detection coil 37 even when each coil is formed in a sheet coil shape with a small number of windings.

<2. Structure of Detection-Side Sheet Coil Part>

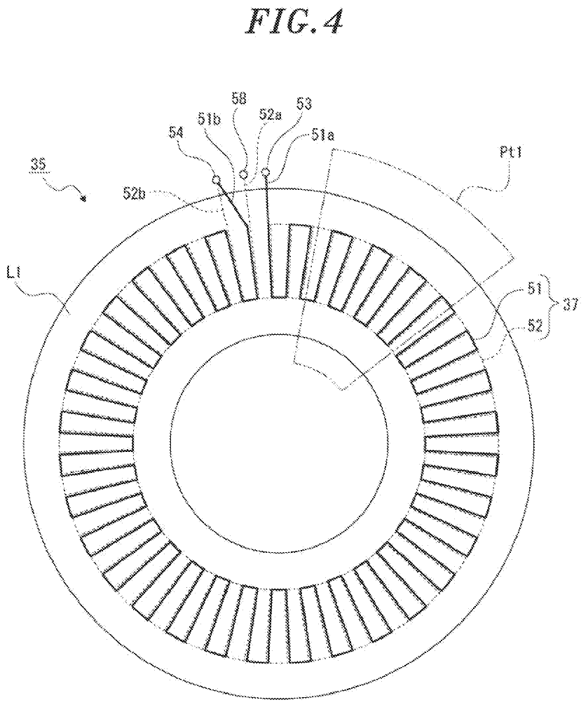

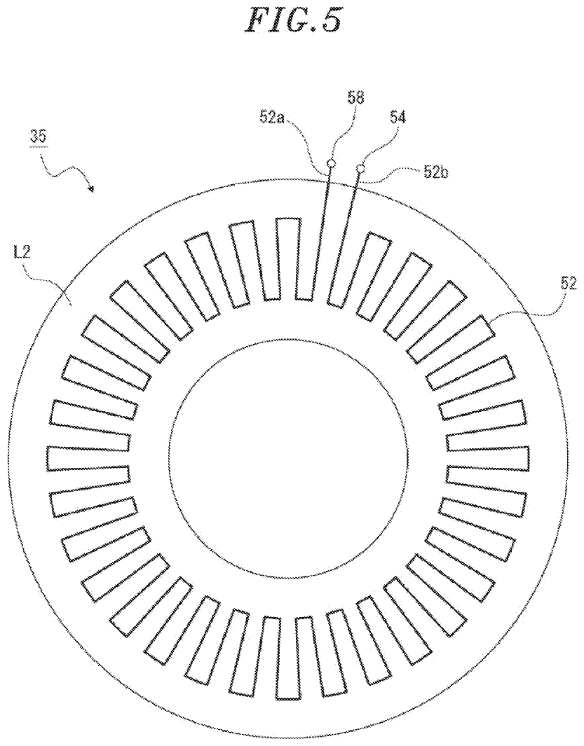

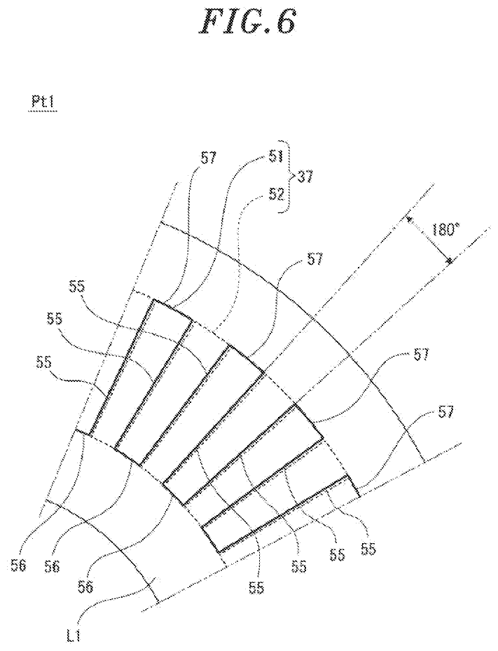

A structure of the detection-side sheet coil part 35 in the present embodiment will be described with reference to FIGS. 4 to 6. FIG. 4 schematically illustrates the detection-side first coil layer L1, and FIG. 5 schematically illustrates the detection-side second coil layer L2. FIG. 6 is an enlarged view of region Pt1 of the detection-side first coil layer L1 illustrated in FIG. 4.

In the detection-side sheet coil part 35, as illustrated in FIGS. 1 and 2, the detection-side first coil layer L1 is formed on the side of the surface 36a of the insulating layer 36 formed in a ring shape, and the detection-side second coil layer L2 is formed on the side of the rear surface 36b.

As illustrated in FIGS. 4 and 5, the detection coil 37 includes a first detection coil part 51 formed in the detection-side first coil layer L1 and a second detection coil part 52 formed in the detection-side second coil layer L2.

In addition, in FIG. 4, for convenience of description, a position of the second detection coil part 52 formed in the detection-side second coil layer L2 is virtually illustrated by a dashed line. In addition, a part of the dashed line, which follows along a solid line, is the part that actually matches the solid line in an overlapping direction.

A conductor pattern as the first detection coil part 51 is formed in the detection-side first coil layer L1. When this conductor pattern is subdivided and described, as illustrated in FIG. 6, the conductor pattern may be divided into parts such as radial direction lines 55, inner peripheral lines 56, and outer peripheral lines 57.

The radial direction lines 55 extend in a straight line shape in a radial direction and are formed at equal intervals in a circumferential direction.

The inner peripheral lines 56 are formed at equal intervals on a circumference of an inner peripheral side of the detection-side first coil layer L1. The inner peripheral line 56 connects inner peripheral side ends of the adjacent radial direction lines 55.

The outer peripheral lines 57 are formed at equal intervals on a circumference of an outer peripheral side of the detection-side first coil layer L1. The outer peripheral line 57 connects outer peripheral side ends of the adjacent radial direction lines 55.

By alternately connecting the radial direction lines 55 continuing in the circumferential direction by the inner peripheral lines 56 and the outer peripheral lines 57, the conductor pattern of one first detection coil part 51 as illustrated in FIG. 4 is formed in series.

The second detection coil part 52 is formed of a conductor pattern similar to that of the first detection coil part 51 described above and formed in the detection-side second coil layer L2. At this point, the second detection coil part 52 is formed such that a phase of an electrical angle is made different by 180° with respect to that of the first detection coil part 51.

A connection terminal 53 is provided at one end part 51a of the first detection coil part 51, and the connection terminal 53 is connected to one end part of the primary coil 33 constituting the output transformer 45 of FIG. 3 (see FIG. 4).

Further, the other end part 51b of the first detection coil part 51 is connected to one end part 52b of the second detection coil part 52 via a through hole 54 formed in the insulating layer 36 (see FIG. 5).

Further, a connection terminal 58 is provided at the other end part 52a of the second detection coil part 52 and is connected to the other end part of the primary coil 33 of FIG. 3.

According to the rotation of the rotating part 21 of FIG. 1, the modulated signal Smo generated in the first detection coil part 51 and the second detection coil part 52 is supplied to the angle detector 44 via the output transformer 45 (see FIG. 3).

<3. Structure of Excitation-Side Sheet Coil Part>

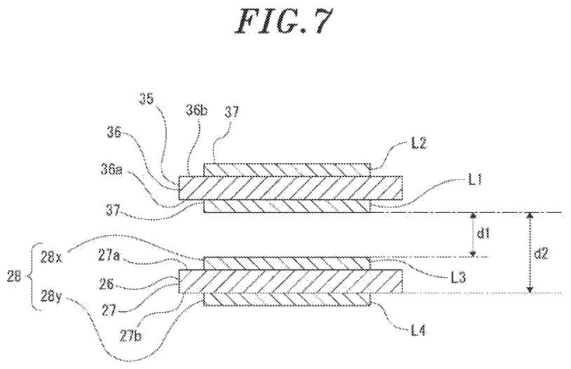

Here, a structure of the excitation-side sheet coil part 26 according to a concept before reaching the present invention is described as Comparative Example (see FIG. 7). FIG. 7 is a side cross-sectional view schematically illustrating a positional relationship between a detection-side sheet coil part 35 and an excitation-side sheet coil part 26 in Comparative Example.

In Comparative Example, a sine coil 28x is formed in an excitation-side first coil layer L3, and a cosine coil 28y is formed in an excitation-side second coil layer L4. The sine coil 28x and the cosine coil 28y are insulated from each other due to the insulating layer 27.

As described above, since the sine coil 28x and the cosine coil 28y are formed in different layers that are the excitation-side first coil layer L3 and the excitation-side second coil layer L4, a distance d1 between the sine coil 28x and a detection coil 37 and a distance d2 between the cosine coil 28y and the detection coil 37 are different. Here, the cosine coil 28y has a longer distance to the detection coil 37 than the sine coil 28x does (d1<d2).

Thus, in the detection-side sheet coil part 35, an amplitude of magnetic flux of a cosine-phase output is less than an amplitude of magnetic flux of a sine-phase output.

As a result, an output difference occurs between the sine-phase output and the cosine-phase output that are detected from the detection coil 37. The difference between magnitudes of the sine-phase output and the cosine-phase output is one factor for reducing the detection accuracy of a rotation angle.

On the other hand, as illustrated in FIG. 2, the excitation-side sheet coil part 26 in the embodiment of the present invention does not cause a difference in distance from the detection coil 37 by providing both the sine coil 28x and the cosine coil 28y in each of the excitation-side first coil layer L3 and the excitation-side second coil layer L4.

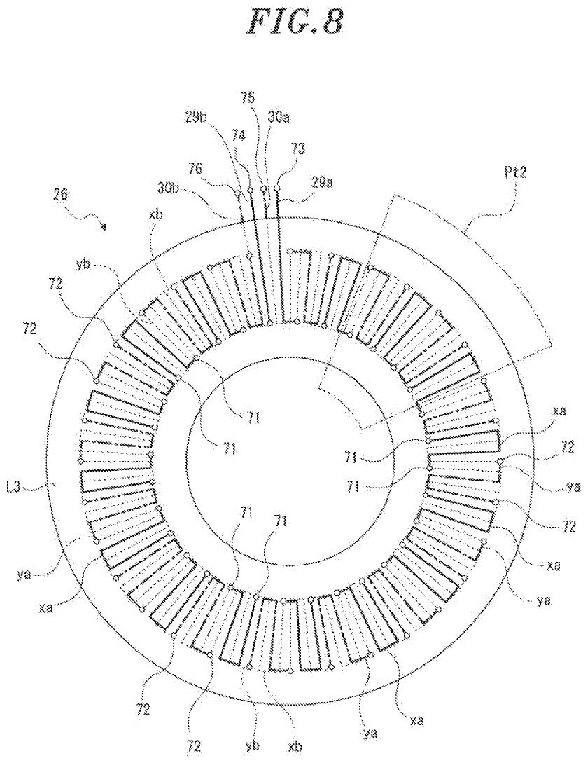

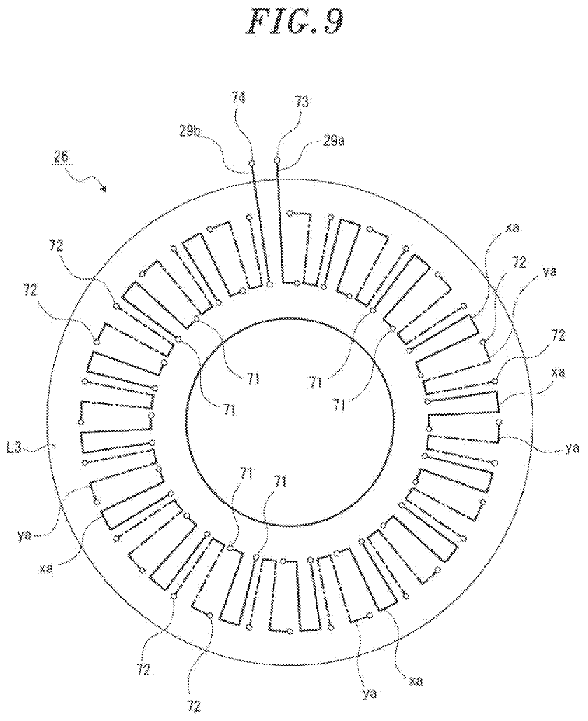

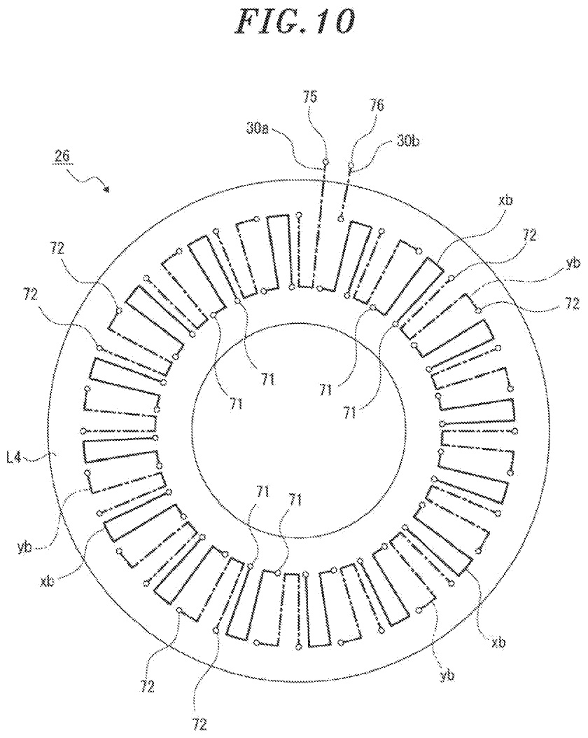

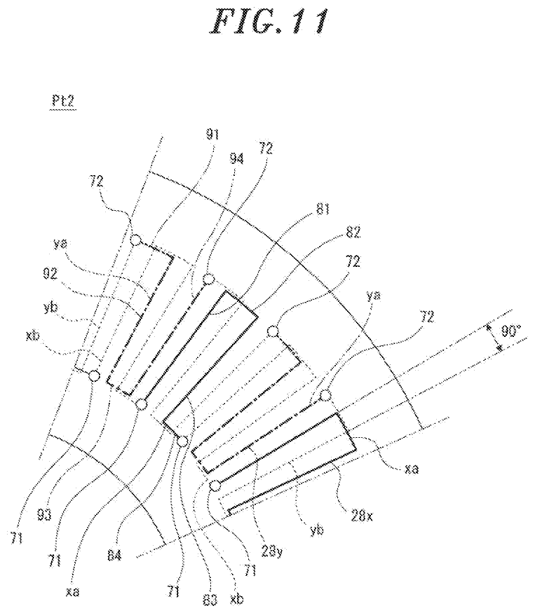

The structure of the excitation-side sheet coil part 26 in the embodiment of the present invention will be described with reference to FIGS. 8 to 11. FIGS. 8 and 9 schematically illustrate the excitation-side first coil layer L3, and FIG. 10 schematically illustrates the excitation-side second coil layer L4. FIG. 11 is an enlarged view of region Pt2 of the excitation-side first coil layer L3 illustrated in FIG. 8.

In the excitation-side sheet coil part 26, as illustrated in FIGS. 1 and 2, the excitation-side first coil layer L3 is formed on the side of the surface 27a of the insulating layer 27 formed in a ring shape, and the excitation-side second coil layer L4 is formed on the side of the rear surface 27b.

In addition, in FIGS. 8 to 11, the cosine coil 28y is illustrated by a dash-single dotted line in order to distinguish the cosine coil 28y from the sine coil 28x. Accordingly, the dash-single dotted line does not indicate that the cosine coil 28y is disconnected.

Further, in FIGS. 8 and 11, for convenience of description, a position of each of the sine coil 28x and the cosine coil 28y formed in the excitation-side second coil layer L4 is virtually illustrated by a dashed line. Here, a part of the dashed line, which follows the solid line or the dash-single dotted line in the circumferential direction, is the part that actually matches the solid line or the dash-single dotted line in the overlapping direction.

A connection terminal 73 is provided at one end part 29a of the sine coil 28x and is connected to one end of the first signal output part 42 illustrated in FIG. 3.

Further, a connection terminal 74 is provided at the other end part 29b of the sine coil 28x and is connected to the other end of the first signal output part 42.

A connection terminal 75 is provided at one end part 30a of the cosine coil 28y and is connected to one end of the second signal output part 43.

Further, a connection terminal 76 is provided at the other end part 30b of the cosine coil 28y and is connected to the other end of the second signal output part 43.

The sine coil 28x includes first sine coil parts xa exposed to the excitation-side first coil layer L3 and second sine coil parts xb exposed to the excitation-side second coil layer L4.

The first sine coil part xa and the second sine coil part xb are connected in series via through holes 71 formed in the insulating layer 27 (see FIG. 8). The through holes are formed at predetermined intervals in the circumferential direction at positions of inner peripheral side ends of a region of the insulating layer 27, in which the first sine coil part xa and the second sine coil part xb are disposed.

Further, the cosine coil 28y includes first cosine coil parts ya exposed to the excitation-side first coil layer L3 and second cosine coil parts yb exposed to the excitation-side second coil layer L4.

The first cosine coil part ya and the second cosine coil part yb are connected in series via through holes 72 formed in the insulating layer 27. The through holes 72 are formed at predetermined intervals in the circumferential direction at positions of outer peripheral side ends of the region of the insulating layer 27, in which the first cosine coil part ya and the second cosine coil part yb are disposed.

In the excitation-side first coil layer L3, the first sine coil parts xa and the first cosine coil parts ya are alternately formed by every one cycle of a conductor pattern in the circumferential direction (see FIG. 9), and in the excitation-side second coil layer L4, the second sine coil parts xb and the second cosine coil parts yb are alternately formed by every one cycle of a conductor pattern in the circumferential direction (see FIG. 10).

At this point, the first sine coil part xa and the second cosine coil part yb are provided at positions opposite to each other with the insulating layer 27 therebetween, and the second sine coil part xb and the first cosine coil part ya are provided at positions opposite to each other with the insulating layer 27 therebetween (see FIG. 11).

The conductor pattern as the first sine coil part xa is formed in the excitation-side first coil layer L3. When this conductor pattern is subdivided and described, as illustrated in FIG. 11, the conductor pattern may be divided into parts such as first radial direction lines 81, first outer peripheral lines 82, first radial direction lines 83, and first inner peripheral lines 84.

The first radial direction line 81 extends in a straight line shape from the through hole 71 in the radial direction, and is connected to one end of the first outer peripheral line extending in the circumferential direction on an outer peripheral side of the excitation-side first coil layer L3. The other end of the first outer peripheral line 82 is connected to the adjacent first radial direction line 83. The first radial direction line 83 extends in a straight line shape in the radial direction and is connected to the first inner peripheral line 84 extending in the circumferential direction on an inner peripheral side of the excitation-side first coil layer L3. The first inner peripheral line 84 is connected to the next through hole 71 formed in an inner peripheral direction. The through holes 71 are formed on a circumference along the first inner peripheral line 84.

One cycle of the conductor pattern of the first sine coil part xa is configured through a part formed by the first radial direction line 81, the first outer peripheral line 82, the first radial direction line 83, and the first inner peripheral line 84.

In addition, the conductor pattern as the first cosine coil part ya is formed in the excitation-side first coil layer L3. This conductor pattern may be subdivided into parts such as second outer peripheral lines 91, second radial direction lines 92, second inner peripheral lines 93, and second radial direction lines 94.

The second outer peripheral line 91 extends in the circumferential direction on the outer peripheral side of the excitation-side first coil layer L3, one end thereof is connected to the through hole 72, and the other end thereof is connected to one end of the second radial direction line 92 extending in a straight line shape in the radial direction. The other end of the second radial direction line 92 is connected to one end of the second inner peripheral line 93 extending along the circumferential direction on the inner peripheral side of the excitation-side first coil layer L3. The other end of the second inner peripheral line 93 is connected to one end of the second radial direction line 94 extending in a straight line shape in the radial direction. The other end of the second radial direction line 94 is connected to the next through hole 72 formed in an outer peripheral direction on the second outer peripheral line 91. The through holes 72 are formed on a circumference along the second outer peripheral line 91.

One cycle of the conductor pattern of the first cosine coil part ya is configured by a part formed by the second outer peripheral line 91, the second radial direction line 92, the second inner peripheral line 93, and the second radial direction line 94.

The conductor pattern of the second sine coil part xb in the excitation-side second coil layer L4 is formed by the same configuration as the conductor pattern of the first sine coil part xa in the excitation-side first coil layer L3 described above.

In addition, the conductor pattern of the second cosine coil part yb in the excitation-side second coil layer L4 is formed by the same configuration as the conductor pattern of the first cosine coil part ya in the excitation-side first coil layer L3 described above.

At this point, as illustrated in FIGS. 9 and 10, the conductor pattern of the second sine coil part xb is formed so that a phase of an electrical angle is made different by 90° with respect to that of the first cosine coil part ya.

In addition, the conductor pattern of the second cosine coil part yb is formed so that a phase of an electrical angle is made different by 90° with respect to that of the first sine coil part xa.

According to the above-described conductor pattern of each of the excitation-side first coil layer L3 and the excitation-side second coil layer L4, as illustrated in FIG. 2, a distance d3 from the detection coil 37 to the first sine coil part xa in the excitation-side first coil layer L3 and a distance d4 from the detection coil 37 to the first cosine coil part ya are equal to each other (d3=d4).

In addition, a distance d5 from the detection coil 37 to the second sine coil part xb in the excitation-side second coil layer L4 and a distance d6 from the detection coil 37 to the second cosine coil part yb are equal to each other (d5=d6).

Accordingly, as a peak value of a magnetic flux density detected from each of the sine coil 28x and the cosine coil 28y becomes the same, the modulated signal Smo may be acquired from the detection coil 37 in a state in which a difference between an output from the cosine coil 28y and an output from the sine coil 28x is corrected.

Further, in the present embodiment, in FIGS. 8 to 11, the solid line part is described as being the sine coil 28x, and the dash-single dotted line part is described as being the cosine coil 28y, but the solid line part may be the cosine coil 28y, and the dash-single dotted line part may be the sine coil 28x.

Further, the present invention may also be implemented as in the following embodiment.

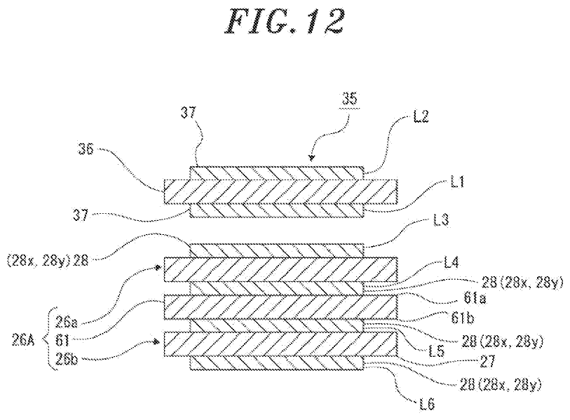

A structure of an excitation-side sheet coil part 26A in the present embodiment of the present invention will be described with reference to FIGS. 12 to 14B.

FIG. 12 is a side cross-sectional view schematically illustrating a positional relationship between a detection-side sheet coil part 35 and the excitation-side sheet coil part 26A.

The excitation-side sheet coil part 26A includes sheet coil parts 26a and 26b and an insulating layer 61. Each of the sheet coil parts 26a and 26b has the same structure as the excitation-side sheet coil part 26 illustrated in FIG. 2 or the like.

Further, for convenience of description, a part corresponding to an excitation-side first coil layer L3 of the sheet coil part 26b is distinguished and referred to as an excitation-side third coil layer L5, and a part corresponding to an excitation-side second coil layer L4 of the sheet coil part 26b is distinguished and referred to as an excitation-side fourth coil layer L6.

The sheet coil part 26a and the sheet coil part 26b are overlapped so as to be opposite to each other with the insulating layer 61 formed in a ring shape therebetween. As a result, the excitation-side second coil layer L4 is formed on a surface 61a of the insulating layer 61, and the excitation-side third coil layer L5 is formed on a rear surface 61b of the insulating layer 61.

Excitation coils 28x and 28y of the sheet coil part 26a and excitation coils 28x and 28y of the sheet coil part 26b are insulated from each other due to the insulating layer 61 and are connected to each other via through holes (not shown) formed in the insulating layer 61.

For example, when description is made using FIG. 8 as an example, the sine coil 28x of the excitation-side sheet coil part 26A is formed by connecting a connection terminal 74 of the sine coil 28x of the sheet coil part 26a in series with a connection terminal 74 of the sine coil 28x of the sheet coil part 26b via the through hole of the insulating layer 61.

The connection terminal 73 on a side of the sheet coil part 26a in the sine coil 28x of the excitation-side sheet coil part 26A is connected to one end of the first signal output part 42 illustrated in FIG. 3. In addition, the connection terminal 73 on a side of the sheet coil part 26b in the sine coil 28x is connected to the other end of the first signal output part 42.

Further, the cosine coil 28y of the excitation-side sheet coil part 26A is formed by connecting a connection terminal 76 of the cosine coil 28y of the sheet coil part 26a in series with a connection terminal 76 of the cosine coil 28y of the sheet coil part 26b via the through hole of the insulating layer 61.

A connection terminal 75 on a side of the sheet coil part 26a in the cosine coil 28y of the excitation-side sheet coil part 26A is connected to one end of the second signal output part 43 illustrated in FIG. 3. In addition, a connection terminal 75 on a side of the sheet coil part 26b in the cosine coil 28y is connected to the other end of the second signal output part 43.

Further, the excitation coils 28x and 28y of the sheet coil part 26a and the excitation coils 28x and 28y of the sheet coil part 26b are provided such that cycles of the conductor patterns thereof are shifted from each other.

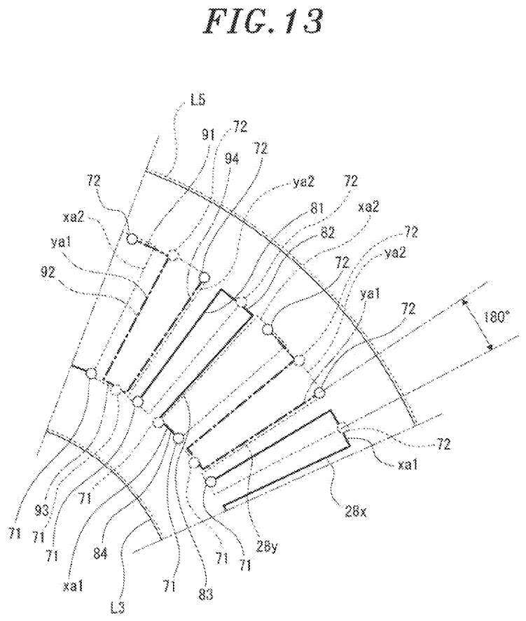

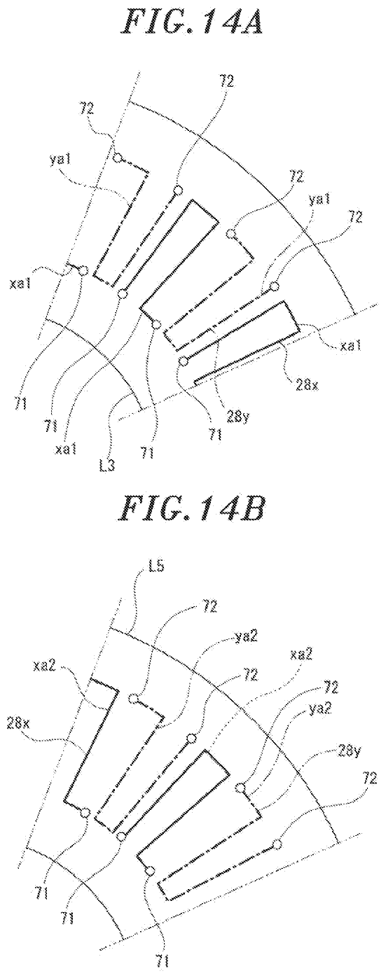

Here, referring to FIGS. 13, 14A, and 14B, a positional relationship of the conductor patterns of the excitation coils 28x and 28y will be described. Here, as an example, a partial region of the excitation-side sheet coil part 26A is extracted and described for the positional relationship between the sine coil 28x of the excitation-side first coil layer L3 and the sine coil 28x of the excitation-side third coil layer L5 to be described below.

Further, for convenience of description, the first sine coil part xa and the first cosine coil part ya of the excitation-side first coil layer L3 are distinguished and referred to as a sine coil part xa1 and a cosine coil part ya1, respectively, and the first sine coil part xa and the first cosine coil part ya of the excitation-side third coil layer L5 are distinguished and referred to as a sine coil part xa2 and a cosine coil part ya2, respectively.

Further, in FIG. 13, for convenience of description, the cosine coil 28y is illustrated by a dash-single dotted line for the same reason as in FIG. 8 or the like. Further, a dashed line part in this drawing is a part in which a configuration of the excitation-side third coil layer L5 is virtually illustrated, and a part of the dashed line, which follows the solid line or the dash-single dotted line, is the part that actually matches the solid line or the dash-single dotted line in the overlapping direction.

FIG. 14A illustrates the components extracted from the excitation-side first coil layer L3 illustrated in FIG. 13, and FIG. 14B illustrates the components extracted from the excitation-side third coil layer L5 illustrated in FIG. 13. In addition, in FIG. 14B, the part illustrated by the dashed line in FIG. 13 is illustrated by a solid line or a dash-single dotted line in the same manner as in FIG. 8.

As illustrated in FIG. 13, the sine coil part xa1 and the sine coil part xa2 opposite to each other with the insulating layer 61 therebetween are provided such that the conductor patterns thereof are shifted from each other by half a cycle. As a result, the sine coil part xa2 is formed so that a phase of an electrical angle is made different by 180° with respect to that of the sine coil part xa1.

Here, one cycle is the conductor pattern configured of a part formed by the first radial direction line 81, the first outer peripheral line 82, the first radial direction line 83, and the first inner peripheral line 84 illustrated in FIG. 11.

Further, the cosine coil part ya1 and the cosine coil part ya2 opposite to each other are also provided such that the conductor patterns thereof are shifted from each other by half a cycle. As a result, the cosine coil part ya2 is formed so that a phase of an electrical angle is made different by 180° with respect to that of the cosine coil part ya1.

Here, one cycle is the conductor pattern configured by a part formed by the second outer peripheral line 91, the second radial direction line 92, the second inner peripheral line 93, and the second radial direction line 94 illustrated in FIG. 11.

Further, although not shown in the drawings, in the same manner as described above, the second sine coil part xb of the excitation-side second coil layer L4 and the second sine coil part xb of the excitation-side fourth coil layer L6 are also provided such that the conductor patterns thereof are shifted from each other by half a cycle, and the second cosine coil part yb of the excitation-side second coil layer L4 and the second cosine coil part yb of the excitation-side fourth coil layer L6 are also provided such that the conductor patterns thereof are shifted from each other by half a cycle.

Magnetic flux generated in a region on an outer peripheral side of the first outer peripheral lines 82 and the second outer peripheral lines 91 forming the conductor pattern (hereinafter also referred to as an outer peripheral region) or a region on an inner peripheral side of the first inner peripheral lines 84 and the second inner peripheral lines 93 (hereinafter also referred to as an inner peripheral region) may reduce the accuracy of the angle detection, and thus, according to the configuration of the conductor pattern, in addition to the magnetic flux in an original direction, magnetic flux in an opposite direction is generated in the outer peripheral region and the inner peripheral region, so that the magnetic fluxes cancel each other.

Since the magnetic flux in the outer peripheral region and the inner peripheral region, which is unnecessary for the angle detection, is canceled, an amplitude of the magnetic flux required for the angle detection may be accurately detected in the detection-side sheet coil part 35. Thus, it is possible to secure or improve the detection accuracy of the rotation angle.

<4. Summary and Modified Example>

The resolver 1 in the present embodiment described above includes the main body 2 (see FIG. 1) having the excitation coil 28, to which the excitation signals Sx and Sy (modulated signals Smx and Smy) are input, and the detection coil 37 configured to output the detection signal So (modulated signal Smo), wherein one of the excitation coil 28 and the detection coil 37 is provided in the fixed part 22, and the other one thereof is provided in the rotating part 21, and the signal processor 3 (see FIG. 3) configured to detect a rotation angle of the rotating part 21 on the basis of the detection signal So that changes in accordance with the rotation angle.

In the resolver 1 in this embodiment, the fixed part 22 or the rotating part 21 in which the excitation coil 28 is provided includes the excitation-side first coil layer L3 (a first coil layer) and the excitation-side second coil layer L4 (a second coil layer) each formed in a planar shape, and the insulating layer 27 formed between the excitation-side first coil layer L3 and the excitation-side second coil layer L4 (see FIG. 2).

Here, the excitation coil 28 includes the sine coil 28x and the cosine coil 28y, and the sine coil 28x is formed by connecting the first sine coil part xa formed in the excitation-side first coil layer L3 and the second sine coil part xb formed in the excitation-side second coil layer L4 via the through holes 71 (first through holes) formed in the insulating layer 27 (see FIGS. 8 to 11).

Further, the cosine coil 28y is formed by connecting the first cosine coil part ya formed in the excitation-side first coil layer L3 and the second cosine coil part yb formed in the excitation-side second coil layer L4 via the through holes (second through holes) formed in the insulating layer 27.

In the excitation-side first coil layer L3, the first sine coil part xa and the first cosine coil part ya are alternately provided in the circumferential direction, and in the excitation-side second coil layer L4, the second sine coil part xb and the second cosine coil part yb are alternately provided in the circumferential direction.

As a result, the distance d3 from the detection coil 37 to the first sine coil part xa (see FIG. 2) and the distance d4 from the detection coil 37 to the first cosine coil part ya become equal to each other (d3=d4), and the distance d5 from the detection coil 37 to the second sine coil part xb and the distance d6 from the detection coil 37 to the second cosine coil part yb become equal to each other (d5=d6).

Accordingly, peak values of a magnetic flux density detected from each of the sine coil 28x and the cosine coil 28y become the same, and the detection signal So (modulated signal Smo) may be acquired in a state in which a difference between an output from the cosine coil 28y and an output from the sine coil 28x is corrected.

Accordingly, it is possible to suppress a decrease in detection accuracy of a rotation angle caused by a difference in distance between the detection coil 37 and each of the two-phase excitation coils 28, thereby maintaining or improving the detection accuracy.

In the resolver 1 in the present embodiment, the first sine coil part xa and the first cosine coil part ya are alternately provided by every one cycle, and the second sine coil part xb and the second cosine coil part yb are alternately provided by every one cycle (see FIGS. 8 to 11).

As a result, a difference in the amount of magnetic flux, which is generated from the sine coil 28x and the cosine coil 28y in the excitation coil 28, linked to the detection coil 37 becomes smaller (substantially the same).

Accordingly, a difference between an output from the cosine coil 28y and an output from the sine coil 28x is corrected, and the detection accuracy of the rotation angle of the rotating part 21 may be maintained or improved.

In the resolver 1 in the present embodiment, the first sine coil part xa and the second cosine coil part yb are provided at positions opposite to each other with the insulating layer 27 therebetween, and the second sine coil part xb and the first cosine coil part ya are provided at positions opposite to each other with the insulating layer 27 therebetween (see FIGS. 8 and 11).

As a result, a space for disposing the sine coil 28x or the cosine coil 28y is sufficiently secured.

Accordingly, the number of poles of the sine coil 28x and the cosine coil 28y may be sufficiently secured, and the detection accuracy of the rotation angle of the rotating part 21 may be maintained or improved.

In the resolver 1 of the present embodiment, one cycle of the first sine coil part xa formed in the excitation-side first coil layer L3 is formed by connecting the first outer peripheral line 82 and the first inner peripheral line 84 via the first radial direction lines 81 and 83, one cycle of the first cosine coil part ya is formed by connecting the second outer peripheral line 91 and the second inner peripheral line via the second radial direction lines 92 and 94, the through holes 71 are formed on a circumference along the first inner peripheral lines 84, and the through holes 72 are formed on a circumference along the second outer peripheral line 91 (see FIG. 11).

Further, similarly to the excitation-side first coil layer L3, one cycle of the second sine coil part xb formed in the excitation-side second coil layer L4 is formed by connecting the first outer peripheral line 82 and the first inner peripheral line 84 via the first radial direction lines 81 and 83, one cycle of the second cosine coil part yb is formed by connecting the second outer peripheral line 91 and the second inner peripheral line 93 via the second radial direction lines 92 and 94, the through holes 71 are formed on the circumference along the first inner peripheral lines 84, and the through holes 72 are formed on the circumference along the second outer peripheral line 91 (see FIG. 11).

In addition, the through holes 71 may be formed on a circumference along the first outer peripheral line 82. At this point, the through hole 72 is formed, for example, on a circumference along the second inner peripheral line 93.

As a result, an output from each of the first sine coil part xa and the first cosine coil part ya (the second sine coil part xb and the second cosine coil part yb) is not interfered with by the through holes 71 and 72 formed in the insulating layer 27.

When the through holes 71 and 72 are formed on the line of the sine coil 28x or the cosine coil 28y, for example, the first radial direction lines 81 and 83 or the second radial direction lines 92 and 94, an output of each of the sine coil 28x and the cosine coil 28y may interfere with each other to cause distortion in a magnetic flux density distribution.

Thus, by providing the through holes 71 and 72 on the circumference of the first outer peripheral line 82 (the second outer peripheral line 91) or the first inner peripheral line 84 (the second inner peripheral line 93) having less influence on the output of each of the sine coil 28x and the cosine coil 28y, the distortion in the magnetic flux density distribution may be prevented, so that the detection accuracy of the rotation angle of the rotating part 21 may be secured.

In the present embodiment, as a configuration example of the resolver 1, the example in which the detection-side sheet coil part 35 is provided in the rotating part 21 and the excitation-side sheet coil part 26 is provided in the fixed part 22 has been described. However, the excitation-side sheet coil part 26 may be provided in the rotating part 21, and the detection-side sheet coil part 35 may be provided in the fixed part 22.

Further, in the present embodiment, the detection-side sheet coil part 35 has been described as having a two-layer structure in which the detection-side first coil layer L1 on which the first detection coil part 51 is formed and the detection-side second coil layer L2 on which the second detection coil part 52 is formed are provided with the insulating layer 36 therebetween (see FIG. 2 or the like), but the detection-side sheet coil part 35 may have a structure of three or more layers or a single layer structure.

Finally, the effects described in the present disclosure are illustrative and not restrictive, and other effects may be exhibited, or some of the effects described in the present disclosure may be provided. Further, the embodiments described in the present disclosure are merely examples, and the present invention is not limited to the above-described embodiments. Therefore, it will be apparent that various modifications may be made depending on the design or the like even when they are other than the above-described embodiment within a range that does not depart from the technical spirit of the present invention. In addition, it should be noted that all combinations of the components described in the embodiments are not necessarily essential for solving the problems.

1. A resolver comprising:
a main body including an excitation coil to which an excitation signal is input and a detection coil configured to output a detection signal, wherein one of the excitation coil and the detection coil is provided in a fixed part and the other one thereof is provided in a rotating part; and
a signal processor configured to detect a rotation angle of the rotating part on the basis of the detection signal that changes in accordance with the rotation angle,
wherein the fixed part or the rotating part, in which the excitation coil is provided, includes a first coil layer and a second coil layer each formed in a planar shape, and a first insulating layer formed between the first coil layer and the second coil layer,
the excitation coil includes a sine coil and a cosine coil,
the sine coil is formed by connecting a first sine coil part formed in the first coil layer and a second sine coil part formed in the second coil layer through a first through hole formed in the first insulating layer,
the cosine coil is formed by connecting a first cosine coil part formed in the first coil layer and a second cosine coil part formed in the second coil layer through a second through hole formed in the first insulating layer,
in the first coil layer, the first sine coil part and the first cosine coil part are alternately arranged in a circumferential direction, and
in the second coil layer, the second sine coil part and the second cosine coil part are alternately arranged in the circumferential direction.

2. The resolver of claim 1, wherein
the first sine coil part and the first cosine coil part are alternately arranged by every one cycle of a conductor pattern, and
the second sine coil part and the second cosine coil part are alternately arranged by every one cycle of a conductor pattern.

3. The resolver of claim 1, wherein
the first sine coil part and the second cosine coil part are provided at positions opposite to each other with the first insulating layer therebetween, and
the second sine coil part and the first cosine coil part are provided at positions opposite to each other with the first insulating layer therebetween.

4. The resolver of claim 2, wherein
the first sine coil part and the second cosine coil part are provided at positions opposite to each other with the first insulating layer therebetween, and
the second sine coil part and the first cosine coil part are provided at positions opposite to each other with the first insulating layer therebetween.

5. The resolver of claim 2, wherein
the one cycle of the first sine coil part is formed by connecting a first outer peripheral line and a first inner peripheral line via a first radial direction line,
the one cycle of the first cosine coil part is formed by connecting a second outer peripheral line and a second inner peripheral line via a second radial direction line,
the first through hole is formed on a circumference along the first outer peripheral line or on a circumference along the first inner peripheral line, and
the second through hole is formed on a circumference along the second outer peripheral line or on a circumference along the second inner peripheral line.

6. The resolver of claim 2, wherein
the fixed part or the rotating part, in which the excitation coil is provided, further includes a third coil layer and a fourth coil layer each formed in a planar shape, a second insulating layer formed between the third coil layer and the fourth coil layer, and a third insulating layer formed between the second coil layer and the third coil layer,
wherein the sine coil is formed by connecting a third sine coil part formed in the third coil layer and a fourth sine coil part formed in the fourth coil layer through a through hole formed in the second insulating layer, and connecting the second sine coil part and the third sine coil part through a through hole formed in the third insulating layer, and
the cosine coil is formed by connecting a third cosine coil part formed in the third coil layer and a fourth cosine coil part formed in the fourth coil layer through a through hole formed in the second insulating layer, and connecting the second cosine coil part and the third cosine coil part through a through hole formed in the third insulating layer,
in the third coil layer, the third sine coil part and the third cosine coil part are alternately provided in the circumferential direction by every one cycle of a conductor pattern,
in the fourth coil layer, the fourth sine coil part and the fourth cosine coil part are alternately provided in the circumferential direction by every one cycle of a conductor pattern,
the first sine coil part and the third sine coil part are provided at positions opposite to each other with the third insulating layer therebetween such that conductor patterns thereof are shifted from each other by half a cycle, and
the first cosine coil part and the third cosine coil part are provided at positions opposite to each other with the third insulating layer therebetween such that conductor patterns thereof are shifted from each other by half a cycle.

7. The resolver of claim 5, wherein
the fixed part or the rotating part, in which the excitation coil is provided, further includes a third coil layer and a fourth coil layer each formed in a planar shape, a second insulating layer formed between the third coil layer and the fourth coil layer, and a third insulating layer formed between the second coil layer and the third coil layer,
wherein the sine coil is formed by connecting a third sine coil part formed in the third coil layer and a fourth sine coil part formed in the fourth coil layer through a through hole formed in the second insulating layer, and connecting the second sine coil part and the third sine coil part through a through hole formed in the third insulating layer, and
the cosine coil is formed by connecting a third cosine coil part formed in the third coil layer and a fourth cosine coil part formed in the fourth coil layer through a through hole formed in the second insulating layer, and connecting the second cosine coil part and the third cosine coil part through a through hole formed in the third insulating layer,
in the third coil layer, the third sine coil part and the third cosine coil part are alternately provided in the circumferential direction by every one cycle of a conductor pattern,
in the fourth coil layer, the fourth sine coil part and the fourth cosine coil part are alternately provided in the circumferential direction by every one cycle of a conductor pattern,
the first sine coil part and the third sine coil part are provided at positions opposite to each other with the third insulating layer therebetween such that conductor patterns thereof are shifted from each other by half a cycle, and
the first cosine coil part and the third cosine coil part are provided at positions opposite to each other with the third insulating layer therebetween such that conductor patterns thereof are shifted from each other by half a cycle.
